(19) United States
(12) Patent Application Publication
(10) Pub. No.: US 2015/0066593 A1
(43) Pub. Date: Mar. 5, 2015

(54) DETERMINING A PRECISION FACTOR FOR A CONTENT SELECTION PARAMETER VALUE

(71) Applicant: Google Inc., Mountain View, CA (US)

(72) Inventors: Ruoyun Huang, Mountain View, CA (US); Yong Sheng, Mountain View, CA (US); Arthur Asuncion, Mountain View, CA (US); Jonathan Michael Krafcik, Mountain View, CA (US)

(73) Assignee: Google Inc., Mountain View, CA (US)

(21) Appl. No.: 14/014,898

(22) Filed: Aug. 30, 2013

(51) Int. Cl. G06Q 30/02

(52) U.S. Cl. CPC G06Q 30/0202
USPC 705/7.31

(57) ABSTRACT

Systems and methods for content selection with precision controls include receiving device identifier data from multiple sources. A machine learning model may be applied to the device identifier data and content selection parameter values may be predicted. Percentiles for the predicted content selection parameter values may be analyzed to determine precision factors for the predicted content selection parameter values.

### BACKGROUND

Online content may be received from various first-party or third-party sources. In general, first-party content refers to the primary online content requested or displayed by a user's device. For example, first-party content may be a webpage requested by the client or a stand-alone application (e.g., a video game, a chat program, etc.) running on the device. Third-party content, in contrast, refers to additional content that may be provided in conjunction with the first-party content. For example, third-party content may be a public service announcement or advertisement that appears in conjunction with a requested webpage (e.g., a search result webpage from a search engine, a webpage that includes an online article, a webpage of a social networking service, etc.) or within a stand-alone application (e.g., an advertisement within a game). More generally, a first-party content provider may be any content provider that allows another content provider (i.e., a third-party content provider) to provide content in conjunction with that of the first-party content provider.

### SUMMARY

Implementations of the systems and methods for determining a precision factor for a content selection parameter value are disclosed herein. One implementation is a method of determining a precision factor for a content selection parameter value. The method includes receiving, at one or more processors, device identifier data from multiple sources including data indicative of online actions associated with a device identifier or user-specified data. The method also includes applying, by the one or more processors, a machine learning model to the device identifier data. The method further includes determining predicted content selection parameter values and percentiles using the machine learning model and the device identifier data. The method also includes applying, by the one or more processors, a posterior calibration to the content selection parameter values and percentiles. The method additionally includes determining one or more precision factors associated with the predicted content selection parameter values.

Another implementation is a system that includes one or more processors operable to receive device identifier data from multiple sources including data indicative of online actions associated with a device identifier or user-specified data. The one or more processors are also operable to apply a machine learning model to the device identifier data and to determine predicted content selection parameter values and percentiles using the machine learning model and the device identifier data. The one or more processors are further operable to apply a posterior calibration to the content selection parameter values and percentiles. The one or more processors are additionally operable to determine one or more precision factors associated with the predicted content selection parameter values.

A further implementation is a computer-readable storage medium having machine instructions stored therein, the instructions being executable by a processor to cause the processor to perform operations. The operations include receiving device identifier data from multiple sources including data indicative of online actions associated with a device identifier or user-specified data. The operations also include applying a machine learning model to the device identifier data. The operations further include determining predicted content selection parameter values and percentiles using the machine learning model and the device identifier data. The operations also include applying a posterior calibration to the content selection parameter values and percentiles. The operations yet further include determining one or more precision factors associated with the predicted content selection parameter values.

These implementations are mentioned not to limit or define the scope of the disclosure, but to provide an example of an implementation of the disclosure to aid in understanding thereof. Particular implementations may be developed to realize one or more of the following advantages.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of an implementation of a computer system in which third-party content is selected for presentation with first-party content;

FIG. 2 is an illustration of one implementation of an electronic display showing a first-party webpage with embedded third-party content;

FIG. 3 is an illustration of one implementation of an interface configured to allow a third-party content provider to specify content selection parameters with precision controls;

FIG. 4 is a block diagram of one implementation of the content selection service shown in FIG. 1; and

FIG. 5 is a flow diagram of one implementation of a process for determining precision factors.

Like reference numbers and designations in the various drawings indicate like elements.

### DETAILED DESCRIPTION

According to various aspects of the present disclosure, a first-party content provider may allow a content selection service to determine which third-party content is to be provided in conjunction with the first-party provider's content. In exchange for doing so, the first-party content provider may receive a portion of any revenues collected by the content selection service from third-party content providers. For example, a website operator may allow third-party advertisements to be selected by a content selection service for placement on the pages of the website. In turn, the content selection service may charge the third-party content providers that place content on the website a certain amount and apportion a percentage of this amount to the first-party content provider.

A content selection service may be configured to base the selection of third-party content on any number of content selection parameters specified by a third-party content provider. For example, a third-party advertiser may use content selection parameters to control which devices receive advertisements from the advertiser. Content selection parameters may be of any type, such as parameters that control the types of devices eligible to receive the third-party content (e.g., based on whether the device is a desktop device, mobile device, tablet device, etc.) or the configuration of the devices (e.g., based on a device's operating system, hardware configuration, etc.). Further content selection parameters may control with which first-party content the third-party content may be presented. For example, some content selection parameters may correspond to search keywords (e.g., if the third-party content is to be presented with search results), topical categories (e.g., if the third-party content is to be presented on first-party websites or in first-party applications), or other characteristics of the first-party content. In some cases, a third-party content provider may even be able to specify specific first-party websites or applications with which the third-party content may be presented.

A content selection service may be configured to allow the use of content selection parameters corresponding to characteristics of a user (e.g., information about a user's social network, social actions or activities, a user's preferences, a user's current location, a user's demographics, etc.). In such cases, the content selection service may take additional steps to ensure the privacy of the user. For example, the user may be provided with an opportunity to control which programs or features collect information about the user, the types of information that may be collected, and/or how third-party content may be selected by the content selection service and presented to the user. Certain data, such as a device identifier, may be anonymized in one or more ways before it is stored or used, so that personally identifiable information is removed when generating content selection parameters used by the content selection service to select third-party content. For example, a device identifier may be anonymized so that no personally identifiable information about its corresponding user can be determined by the content selection service from it. In another example, a user's geographic location may be generalized where location information is obtained (such as to a city, ZIP code, or state level), so that a precise location of the user cannot be determined. Thus, the user of a device may have control over how information is collected about him or her and used by the content selection service.

A content selection service may predict content selection parameter values regarding a user, while still taking measures that ensure the privacy of the user. In other words, a content selection service may not use personally identifiable information about the user, but may still attempt to estimate characteristics of the user to control which content is selected for presentation by the user's device. For example, the content selection service may use selection parameter values corresponding to a user's estimated age or gender to control which third-party content is eligible to be selected for presentation by the device of the user. In some cases, the service may be configured to combine different parameters into a single content selection parameter. For example, the content selection service may use a content selection parameter that has a value corresponding to a combination of a predicted age and gender. In some implementations, the content selection service may also determine precision factors associated with any predicted content selection parameter values. The precision factors may represent a degree of confidence in the predicted content selection parameter values. For example, an estimated content selection parameter value may have an associated precision of 80%, indicating an 80% chance that the actual characteristic of the user matches the estimated value of the content selection parameter.

In some implementations, a content selection service may be configured to allow a third-party content provider to specify a precision factor when using a content selection parameter. For example, a third-party content provider may specify a content selection parameter value corresponding to an age range of 24-34 and/or a gender of female with a precision of 85%. As the degree of precision increases, the pool of devices eligible to receive content from the provider decreases. Conversely, lowering the degree of precision increases the potential audience for the provider's content. Thus, different third-party content providers may use different precision factors for the same content selection parameter value, depending on the goals of the provider.

To estimate content selection parameters for a particular device identifier, multiple sources of information may be used by a content selection service. In some cases, the content selection service may receive content selection parameter values based on data from one or more third-party content providers. For example, the content selection service may receive data from one or more third-party content sources for a device identifier that is indicative of a content selection parameter (e.g., the user associated with the device identifier specifies his or her age or gender as part of his or her profile, content from the third-party source can be used to estimate the user's age or gender, etc.). Similarly, the content selection service may receive content selection parameter values based on data from one or more other services offered by the same entity as the content selection service. For example, data from a social networking service, video sharing service, email service, etc. offered by the same entity as the content selection service may be used by the content selection service as content selection parameter values for a device identifier. In further implementations, long-term browsing history data (e.g., from the previous day, week, month, etc.), short-term browsing history data (e.g., from the previous day, previous hour, etc.), and/or current browsing history data (e.g., from the most recently visited webpage) for a device identifier may be used to predict content selection parameter values for the device identifier.

In cases in which multiple sources of data are used to determine a content selection parameter value for a device identifier, a content selection service may be configured to analyze content selection parameter values from multiple sources to increase the degree of precision for the finalized value. According to various implementations, content selection parameter values from third-party providers, other services associated with the content selection service, long-term browsing history data, short-term browsing history data, and/or current browsing history data may be analyzed using one or more machine learning models to determine a finalized set of one or more content selection parameter values for a device identifier. In one implementation, for example, the content selection service may use an ensemble machine learning model that combines the results of multiple machine learning models (e.g., heuristic models, random forest models, logistic regression models, etc.) to determine finalized content selection parameter values for a device identifier. The ensemble model may, in some cases, give priority to certain data sources over others when determining the finalized content selection parameter values (e.g., parameter values based on third-party provided data may be considered more reliable than parameter values based on the current browsing history). The content selection service may also be configured to determine the posterior distributions for the finalized content selection parameter values. For example, the posterior distributions may denote how probable a device identifier is actually in a particular range of values, given all available information associated with the device identifier. The content selection service may use these distributions, in some implementations, to select the narrowest range of content selection parameter values having a threshold degree of precision. For example, the content selection service may determine that the narrowest content selection parameter value for a device identifier that has a precision of 85% or greater corresponds to the user represented by the device identifier being a female between the ages of 18-24 (e.g., the age range of 18+ may have an even higher precision factor, but the narrower 18-24 age range also satisfies the precision threshold).

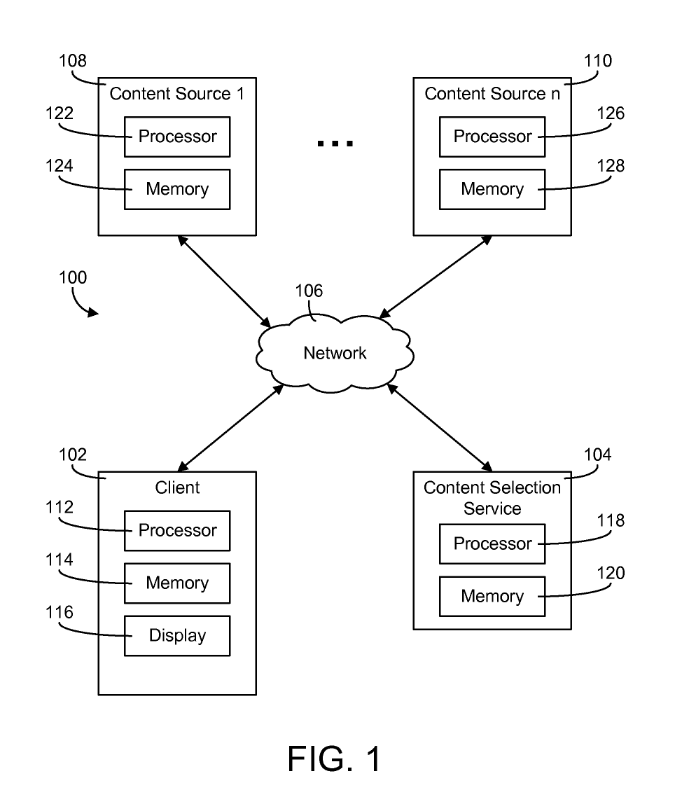

Referring to FIG. 1, a block diagram of a computer system 100 in accordance with a described implementation is shown. System 100 includes a client device 102 which communicates with other computing devices via a network 106. Client device 102 may execute a web browser or other application (e.g., a video game, a messenger program, a media player, a social networking application, etc.) to retrieve content from other devices over network 106. For example, client device 102 may communicate with any number of content sources 108, 110 (e.g., a first content source through nth content source). Content sources 108, 110 may provide webpage data and/or other content, such as images, video, and audio, to client device 102. Computer system 100 may also include a content selection service 104 configured to select third-party content to be provided to client device 102. For example, content source 108 may provide a first-party webpage to client device 102 that includes additional third-party content selected by content selection service 104.

Network 106 may be any form of computer network that relays information between client device 102, content sources 108, 110, and content selection service 104. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, client device 102 may communicate wirelessly (e.g., via WiFi, cellular, radio, etc.) with a transceiver that is hardwired (e.g., via a fiber optic cable, a CATS cable, etc.) to other computing devices in network 106.

Client device 102 may be any number of different types of user electronic devices configured to communicate via network 106 (e.g., a laptop computer, a desktop computer, a tablet computer, a smartphone, a digital video recorder, a set-top box for a television, a video game console, combinations thereof, etc.). In some implementations, the type of client device 102 may be categorized as being a mobile device, a desktop device (e.g., a device intended to remain stationary or configured to primarily access network 106 via a local area network), or another category of electronic devices (e.g., tablet devices may be a third category, etc.). Client device 102 is shown to include a processor 112 and a memory 114. Memory 114 may store machine instructions that, when executed by processor 112 cause processor 112 to perform one or more of the operations described herein. Processor 112 may include a microprocessor, ASIC, FPGA, etc., or combinations thereof. Memory 114 may include, but is not limited to, an electronic, optical, magnetic, or any other storage or transmission device capable of providing processor 112 with program instructions. Memory 114 may include a floppy disk, CD-ROM, DVD, magnetic disk, memory chip, ROM, RAM, EEPROM, EPROM, flash memory, optical media, or any other suitable memory from which processor 112 can read instructions. The instructions may include code from any suitable computer programming language.

Client device 102 may include one or more user interface devices. A user interface device may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interface devices may be internal to the housing of client device 102 (e.g., a built-in display, microphone, etc.) or external to the housing of client device 102 (e.g., a monitor connected to client device 102, a speaker connected to client device 102, etc.), according to various implementations. For example, client device 102 may include an electronic display 116, which displays webpages and other data received from content sources 108, 110 and/or content selection service 104. In various implementations, display 116 may be located inside or outside of the same housing as that of processor 112 and/or memory 114. For example, display 116 may be an external display, such as a computer monitor, television set, or any other stand-alone form of electronic display. In other examples, display 116 may be integrated into the housing of a laptop computer, mobile device, or other form of computing device having an integrated display.

Content sources 108, 110 may be one or more electronic devices connected to network 106 that provide content to devices connected to network 106. For example, content sources 108, 110 may be computer servers (e.g., FTP servers, file sharing servers, web servers, etc.) or combinations of servers (e.g., data centers, cloud computing platforms, etc.). Content may include, but is not limited to, webpage data, media files, search results, other forms of electronic documents, and applications executable by client device 102. For example, content source 108 may be an online search engine that provides search result data to client device 102 in response to a search query. In another example, content source 110 may be a first-party web server that provides webpage data to client device 102 in response to a request for the webpage. Similar to client device 102, content sources 108, 110 may include processors 122, 126 and memories 124, 128, respectively, that store program instructions executable by processors 122, 126. For example, the processing circuit of content source 108 may include instructions such as web server software, FTP serving software, and other types of software that cause content source 108 to provide content via network 106.

According to various implementations, content sources 108, 110 may provide first-party webpage data to client device 102 that includes one or more content tags. In general, a content tag refers to any piece of webpage code associated with the action of including third-party content with a first-party webpage. For example, a content tag may define a slot on a webpage for third-party content, a slot for out of page third-party content (e.g., an interstitial slot), whether third-party content should be loaded asynchronously or synchronously, whether the loading of third-party content should be disabled on the webpage, whether third-party content that loaded unsuccessfully should be refreshed, the network location of a content source that provides the third-party content (e.g., content sources 108, 110, content selection service 104, etc.), a network location (e.g., a URL) associated with clicking on the third-party content, how the third-party content is to be rendered on a display, a command that causes client device 102 to set a browser cookie (e.g., via a pixel tag that sets a cookie via an image request), one or more keywords used to retrieve the third-party content, and other functions associated with providing third-party content with a first-party webpage. For example, content source 108 may serve first-party webpage data to client device 102 that causes client device 102 to retrieve third-party content from content selection service 104. In another implementation, content may be selected by content selection service 104 and provided by content source 108 as part of the first-party webpage data sent to client device 102. In a further example, content selection service 104 may cause client device 102 to retrieve third-party content from a specified location, such as memory 114 or content sources 108, 110.

Content selection service 104 may also be one or more electronic devices connected to network 106. Content selection service 104 may be a computer server (e.g., FTP servers, file sharing servers, web servers, etc.) or a combination of servers (e.g., a data center, a cloud computing platform, etc.). Content selection service 104 may include a processor 118 and a memory 120 that stores program instructions executable by processor 118. In cases in which content selection service 104 is a combination of computing devices, processor 118 may represent the collective processors of the devices and memory 120 may represent the collective memories of the devices.

Content selection service 104 may be configured to select third-party content for presentation by client device 102. In one implementation, the selected third-party content may be provided by content selection service 104 to client device 102 via network 106. For example, content source 110 may upload the third-party content to content selection service 104. Content selection service 104 may then provide the third-party content to client device 102 to be presented in conjunction with first-party content provided by content source 108. In other implementations, content selection service 104 may provide an instruction to client device 102 that causes client device 102 to retrieve the selected third-party content (e.g., from memory 114 of client device 102, from content source 110, etc.). For example, content selection service 104 may select third-party content to be provided as part of a first-party webpage being visited by client device 102 or within a first-party application being executed by client device 102 (e.g., within a game, messenger application, etc.).

In some implementations, content selection service 104 may be configured to select content based on data associated with a device identifier for client device 102. In general, a device identifier refers to any form of data that may be used to represent a device or software that receives content selected by content selection service 104. In some implementations, a device identifier may be associated with one or more other device identifiers (e.g., a device identifier for a mobile device, a device identifier for a home computer, etc.). Device identifiers may include, but are not limited to, cookies, device serial numbers, user profile data, or network addresses. For example, a cookie set on client device 102 may be used to identify client device 102 to content selection service 104. Content selection service 104 may use any form of data associated with the device identifier for client device 102 as content selection parameter values that control which types of content are eligible for presentation by client device 102. For example, data associated with the device identifier may indicate the type of device, configuration of the device, or any other such information that can be used to control whether client device 102 is eligible to receive certain third-party content.

Content selection service 104 may use predicted user characteristics to select third-party content that is likely to be relevant to the user of client device 102. In some implementations, data associated with a device identifier for client device 102 may be used by content selection service 104 to predict characteristics of the user of client device 102. Content selection service 104 may also be configured to protect the user's privacy by allowing the user of client device 102 to control what types of information about the user may be collected by content selection service 104, how content selection service 104 uses the information, and/or how content selection service 104 selects third-party content for presentation by client device 102. The device identifier for client device 102 may also be anonymized by content selection service 104 such that personally identifiable information about the user of client device 102 cannot be determined by analyzing the device identifier representing client device 102.

In one implementation, content selection service 104 may receive data indicative of online actions associated with a device identifier. In implementations in which a content tag causes client device 102 to request content from content selection service 104, such a request may include a device identifier for client device 102 and/or additional information (e.g., the webpage being loaded, the referring webpage, etc.). For example, content selection service 104 may receive and store history data regarding whether or not third-party content provided to client device 102 was selected using an interface device (e.g., the user of client device 102 clicked on a third-party hyperlink, third-party image, etc.). Content selection service 104 may store such data to record a history of online events associated with a device identifier (e.g., browsing history data indicative of the webpages or other online resources accessed by the device identifier). In some cases, client device 102 may provide history data to content selection service 104 without first executing a content tag. For example, client device 102 may periodically send history data to content selection service 104 or may do so in response to receiving a command from a user interface device. In some implementations, content selection service 104 may receive history data from content sources 108, 110. For example, content source 108 may store history data regarding web transactions with client device 102 and provide the history data to content selection service 104.

Content selection service 104 may analyze data indicative of online actions to identify one or more topics that may be of interest to the user of client device 102. For example, content selection service 104 may perform text and/or image analysis on a webpage from content source 108, to determine one or more topics of the webpage. In some implementations, a topic may correspond to a predefined interest category used by content selection service 104. For example, a webpage devoted to the topic of golf may be classified under the interest category of sports. In some cases, interest categories used by content selection service 104 may conform to a taxonomy (e.g., an interest category may be classified as falling under a broader interest category). For example, the interest category of golf may be /Sports/Golf, /Sports/Individual Sports/Golf, or under any other hierarchical category. Similarly, content selection service 104 may analyze the content of a first-party webpage accessed by client device 102 to identify one or more topical categories for the webpage. For example, content selection service 104 may use text or image recognition on the webpage to determine that the webpage is devoted to the topical category of /Sports/Golf.

Content selection service 104 may apply one or more weightings to an interest or product category, to determine whether the category is to be associated with a device identifier. For example, content selection service 104 may impose a maximum limit to the number of product or interest categories associated with a device identifier. The top n-number of categories having the highest weightings may then be selected by content selection service 104 to be associated with a particular device identifier. A category weighting may be based on, for example, the number of webpages visited by the device identifier regarding the category, when the visits occurred, how often the topic of the category was mentioned on a visited webpage, or any online actions performed by the device identifier regarding the category. For example, topics of more recently visited webpages may receive a higher weighting than webpages that were visited further in the past. Categories may also be subdivided by the time periods in which the webpage visits occurred. For example, the interest or product categories may be subdivided into long-term, short-term, and current categories, based on when the device identifier visited a webpage regarding the category.

In some implementations, content selection service 104 may use a predictive model to associate a device identifier with a content selection parameter value. The predictive model may be based in part on known parameter values for other device identifiers. For example, assume that at least a portion of the visitors to a particular website log into accounts on the website that include information about the users. Such information may be used in a predictive model to predict the characteristics of other users that also visit the website (e.g., if the average logged in visitor to the website is male, it is likely that another visitor to the website is also male). In one implementation, the predictive model may also generate one or more precision factors associated with a predicted parameter value. For example, the model may predict that a user represented by a device identifier is male, with an 80% degree of confidence. In some cases, the model may predict multiple parameter values for a device identifier. For example, the model may predict that a user represented by a device identifier is between the ages of 24-34 with a precision of 75% and age 18+ with a precision of 98%. Thus, different groupings of overlapping content selection parameter values may result in different precision factors (e.g., the device identifier may be associated with multiple ‘bins’ of content selection parameter values).

Content selection service 104 may be configured to use data from multiple sources to predict content selection parameter values for a device identifier. Data sources that may be used to predict content selection parameter values may include, but are not limited to, a device identifier's current online history (e.g., the webpage or other online resource most recently accessed by the device identifier), short-term history (e.g., the webpages or other online resources accessed by the device identifier within the past hour, several hours, day, or other short-term amount of time), long-term history (e.g., the webpages or other online resources accessed by the device identifier over the previous day, week, month, year, etc.), data from one or more services provided by the same entity as content selection service 104 (e.g., an email service, a social networking service, a media sharing service, etc.), or third-party data from content sources 108-110 (e.g., which webpages or resources were accessed by the device identifier, account information, etc.). For example, content selection service 104 may compare age, gender, age/gender combinations, or other predicted content selection parameter values for a device identifier based on data from different sources to determine one or more finalized content selection parameter values.

In some implementations, content selection service 104 may be configured to determine calibrated posterior distributions for predicted content selection parameter values. In general, calibration in the context of machine classification refers to the process of determining the probabilities of membership in different classes. For example, content selection service 104 may use the following age classifications from its machine learning models as content selection parameter values: 0-17, 18-24, 25-34, 35-44, 45-54, 55-64, 65+. In another example, content selection service 104 may classify a device identifier as belonging to a male or a female. Content selection service 104 may also use multivariable classifications, such as 0-17 and male, 0-17 and female, 18-24 and male, etc. Content selection service 104 may also aggregate data from multiple classifications to generate ‘virtual’ classifications. For example, content selection service 104 may combine the 18-24 and 25-34 age groups to form a virtual age group of 18-34. In some implementations, content selection service 104 may use the probabilities for each classification determined via the posterior calibration as precision factors. For example, a particular device identifier may be classified in the 18-24 year old male category with a precision factor of 85% (e.g., there is an 85% probability that the user represented by the device identifier actually falls within the category).

Content selection service 104 may be configured to compare the precision factors for a device identifier to one or more threshold values. For example, content selection service 104 may compare a device identifier's precision factors for multiple classifications to a threshold value, to determine which classifications (e.g., content selection parameter values) are above the threshold amount (e.g., classifications having precision factors of 85% or higher may be considered to be high precision). In one implementation, content selection service 104 may select the narrowest content selection parameter value satisfying the threshold precision factor. For example, assume that content selection service 104 determines that a device identifier is in the 18+ category with a precision factor of 99%, in the 18-34 category with a precision factor of 90%, and in the 18-24 category with a precision factor of 85%. In such a case, if the threshold value is 80%, content selection service 104 may associate a content selection parameter value corresponding to the 18-24 category with the device identifier.

Content selection service 104 may conduct a content auction among third-party content providers to determine which third-party content is to be provided to client device 102. For example, content selection service 104 may conduct a real-time content auction in response to client device 102 requesting first-party content from one of content sources 108, 110 or executing a first-party application. Content selection service 104 may use any number of factors to determine the winner of the auction. For example, the winner of a content auction may be based in part on the third-party provider's bid and/or a quality score for the third-party provider's content (e.g., a measure of how likely the user of client device 102 is to click on the content). In other words, the highest bidder is not necessarily the winner of a content auction conducted by content selection service 104, in some implementations.

Content selection service 104 may be configured to allow third-party content providers to create campaigns or other groupings (e.g., an advertisement group) to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at client device 102. In other words, the bid amount may be on a cost per impression or cost per thousand impressions (CPM) basis. In further cases, a bid amount may correspond to a specified action being performed in response to the third-party content being presented at a client device. For example, a bid amount may be a monetary amount that the third-party content provider is willing to pay, should their content be clicked on at the client device, thereby redirecting the client device to the provider's webpage. In other words, a bid amount may be a cost per click (CPC) bid amount. In another example, the bid amount may correspond to an action being performed on the third-party provider's website, such as the user of client device 102 making a purchase. Such bids are typically referred to as being on a cost per acquisition (CPA) or cost per conversion basis.

A campaign created via content selection service 104 may also use content selection parameters that control when a bid is placed on behalf of a third-party content provider in a content auction. If the third-party content is to be presented in conjunction with search results from a search engine, for example, the selection parameters may include one or more sets of search keywords. For example, the third-party content provider may only participate in content auctions in which a search query for “golf resorts in California” is sent to a search engine. Other parameters may control when a bid is placed on behalf of a third-party content based on a topic identified using a device identifier's history data (e.g., based on webpages visited by the device identifier or other online actions), the topic of a webpage or other first-party content with which the third-party content is to be presented, a geographic location of the client device that will be presenting the content, a geographic location specified as part of a search query, or predicted user characteristics. In some cases, a selection parameter may designate a specific webpage, website, or group of websites with which the third-party content is to be presented. For example, an advertiser selling golf equipment may specify that they wish to place an advertisement on the sports page of an particular online newspaper.

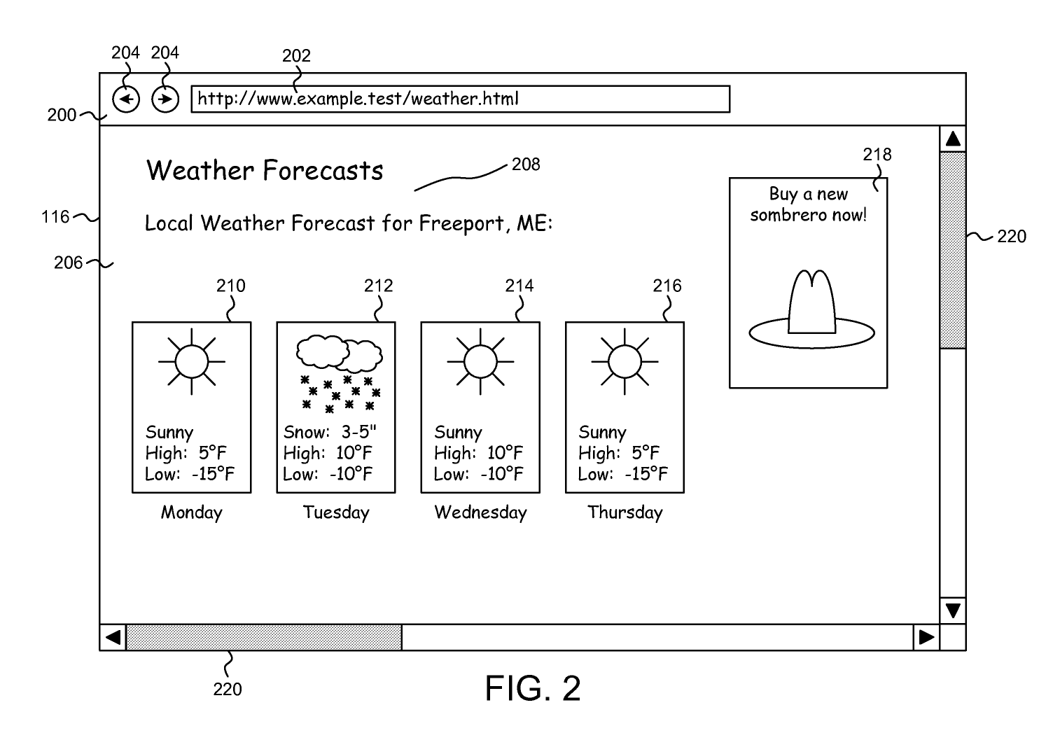

Referring now to FIG. 2, an illustration is shown of electronic display 116 displaying an example first-party webpage 206. Electronic display 116 is in electronic communication with processor 112 which causes visual indicia to be displayed on electronic display 116. As shown, processor 112 may execute a web browser 200 stored in memory 114 of client device 102, to display indicia of content received by client device 102 via network 106. In other implementations, another application executed by client device 102 may incorporate some or all of the functionality described with regard to web browser 200 (e.g., a video game, a chat application, etc.).

Web browser 200 may operate by receiving input of a uniform resource locator (URL) via a field 202 from an input device (e.g., a pointing device, a keyboard, a touch screen, etc.). Processor 112 may use the inputted URL to request data from a content source having a network address that corresponds to the entered URL. In other words, client device 102 may request first-party content accessible at the inputted URL. In response to the request, the content source may return webpage data and/or other data to client device 102. Web browser 200 may analyze the returned data and cause visual indicia to be displayed by electronic display 116 based on the data.

In general, webpage data may include text, hyperlinks, layout information, and other data that may be used to provide the framework for the visual layout of first-party webpage 206. In some implementations, webpage data may be one or more files of webpage code written in a markup language, such as the hypertext markup language (HTML), extensible HTML (XHTML), extensible markup language (XML), or any other markup language. The webpage data may include data that specifies where indicia appear on first-party webpage 206, such as text 208. In some implementations, the webpage data may also include additional URL information used by web browser 200 to retrieve additional indicia displayed on first-party webpage 206.

Web browser 200 may include a number of navigational controls associated with first-party webpage 206. For example, web browser 200 may be configured to navigate forward and backwards between webpages in response to receiving commands via inputs 204 (e.g., a back button, a forward button, etc.). Web browser 200 may also include one or more scroll bars 220, which can be used to display parts of first-party webpage 206 that are currently off-screen. For example, first-party webpage 206 may be formatted to be larger than the screen of electronic display 116. In such a case, the one or more scroll bars 220 may be used to change the vertical and/or horizontal position of first-party webpage 206 on electronic display 116.

First-party webpage 206 may be devoted to one or more topics. For example, first-party webpage 206 may be devoted to the local weather forecast for Freeport, Me. In some implementations, a content selection server, such as content selection service 104, may analyze the contents of first-party webpage 206 to identify one or more topics. For example, content selection service 104 may analyze text 208 and/or images 210-216 to identify first-party webpage 206 as being devoted to weather forecasts. In some implementations, webpage data for first-party webpage 206 may include metadata that identifies a topic.

In various implementations, content selection service 104 may select some of the content presented on first-party webpage 206 (e.g., an embedded image or video, etc.) or in conjunction with first-party webpage 206 (e.g., in a pop-up window or tab, etc.). For example, content selection service 104 may select third-party content 218 to be included on webpage 206. In some implementations, one or more content tags may be embedded into the code of webpage 206 that defines a content field located at the position of third-party content 218. Another content tag may cause web browser 200 to request additional content from content selection service 104, when first-party webpage 206 is loaded. Such a request may include one or more keywords, a device identifier for client device 102, or other data used by content selection service 104 to select content to be provided to client device 102. In response, content selection service 104 may select third-party content 218 for presentation on first-party webpage 206.

Content selection service 104 may select third-party content 218 (e.g., an advertisement) by conducting a content auction, in some implementations. Content selection service 104 may also determine which third-party content providers compete in the auction based in part on values of content selection parameters used by the providers. For example, only content providers that specified a topic that matches that of webpage 206, an interest category of a device identifier accessing webpage 206, or webpage 206 specifically may compete in the content auction. In another example, only content providers that specified a predicted user characteristic associated with the device identifier of client device 102 may participate in the auction. Based on bidding parameters for these third-party content providers, content selection service 104 may compare their bid amounts, quality scores, and/or other values to determine the winner of the auction and select third-party content 218 for presentation with webpage 206.

In some implementations, content selection service 104 may provide third-party content 218 directly to client device 102. In other implementations, content selection service 104 may send a command to client device 102 that causes client device 102 to retrieve third-party content 218. For example, the command may cause client device 102 to retrieve third-party content 218 from a local memory, if third-party content 218 is already stored in memory 114, or from a networked content source. In this way, any number of different pieces of content may be placed in the location of third-party content 218 on first-party webpage 206. In other words, one user that visits first-party webpage 206 may be presented with third-party content 218 and a second user that visits first-party webpage 206 may be presented with different content. Other forms of content (e.g., an image, text, an audio file, a video file, etc.) may be selected by content selection service 104 for display with first-party webpage 206 in a manner similar to that of third-party content 218. In further implementations, content selected by content selection service 104 may be displayed outside of first-party webpage 206. For example, content selected by content selection service 104 may be displayed in a separate window or tab of web browser 200, may be presented via another software application (e.g., a text editor, a media player, etc.), or may be downloaded to client device 102 for later use.

Third-party content 218 may be interactive content. In other words, the user of client device 102 may interact with third-party content 218 via an interface device. For example, third-party content 218 may be clickable (e.g., via a mouse, touch screen, etc.) and hotlinked to a landing webpage of the third-party content provider. In various implementations, webpage 206, third-party content 218, and/or the landing webpage may be configured to cause client device 102 to report a content interaction with third-party content 218 to content selection service 104 and/or to content source 108. In one implementation, webpage 206 and the landing webpage may include pixel tags that allows content selection service 104 to set a cookie on client device 102 and cause client device 102 to report the cookie back to content selection service 104 when the landing webpage is loaded. In another implementation, assume that client device 102 is logged into an account of content source 108 and the landing webpage includes code that causes client device 102 to report that the user of client device 102 clicked on third-party content 218 and was redirected to the hotlinked webpage of the third-party content provider. Content source 108 may then provide the recorded data to content selection service 104. Thus, content selection service 104 may receive data regarding interactions with third-party content 218 by users that are presented the content. If a user is also logged into an account with content source 108, content selection service 104 may also associate the content interaction with the account.

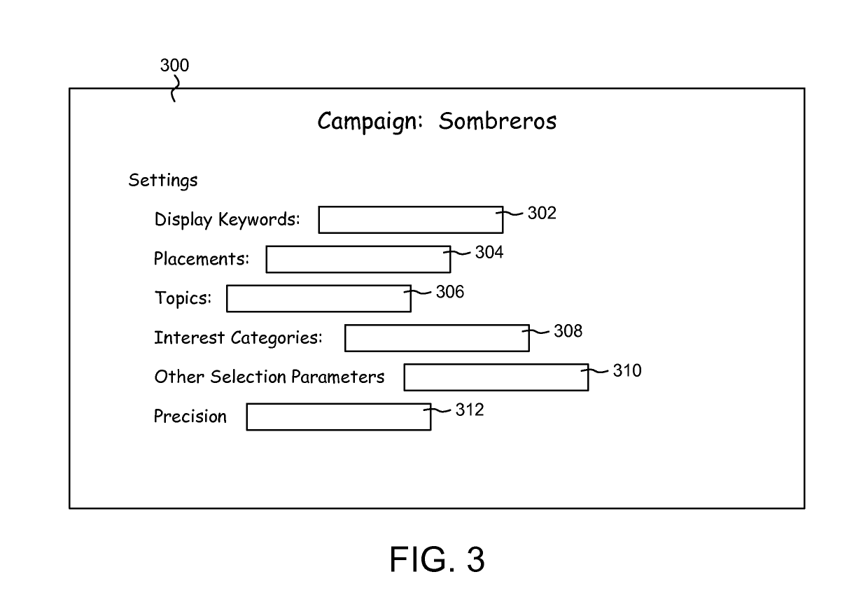

Referring now to FIG. 3, an illustration of one implementation of an interface 300 configured to allow a third-party content provider to specify content selection parameters with precision controls is shown. In the implementation shown, assume that a third-party content provider is an online retailer that sells hats. Interface 300 may be part of a configuration interface that allows the retailer to set up an advertising campaign and to use content selection parameters with the campaign. Based on the specified values of the content selection parameters, the content selection service may determine whether or not the provider's content is eligible for presentation to certain device identifiers.

Interface 300 may include any number of inputs 302-312 configured to receive specified content selection parameter values. Input 302 may receive one or more sets of display keywords. If any display keywords are specified, the third-party content associated with the campaign may only be eligible for presentation on websites that use the specified keywords. For example, if the content providers specifies the keywords “automobile insurance,” the provider's advertisement will only be eligible for presentation on websites that use the same or similar keywords. Input 304 may receive one or more placement values that denote specific websites, webpages, etc. on which the third-party content is eligible for presentation. For example, input 304 may be used in the campaign to limit the appearance of advertisements to a specific first-party website. Input 306 may receive topical categories of first-party content. If any such categories are specified, the content selection service may limit the presentation of the third-party content to first-party content having a matching topic. Input 308 may receive one or more specified interest categories. If a particular device identifier is associated with a matching interest category, it may be eligible to receive the provider's content. For example, an advertiser may specify that he or she only wishes to send advertisements to users that are interested in golf.

Input 310 may receive any other specified content selection parameter value and input 312 may receive a desired level of precision for the value. For example, only device identifiers having a predicted selection value matching the value specified in input 310 may receive the content associated with the campaign. Similarly, only those device identifiers having the predicted value with a precision equal or greater than the precision factor specified in input 312 may be eligible to receive the provider's content. For example, if the provider specifies a degree of precision of 95% via input 312, only those device identifiers having the selection parameter value in input 310 predicted with a level of precision of 95% or greater may potentially receive the provider's content. In one implementation, the content selection service may impose a threshold precision factor to device identifiers, even if a level of precision is not entered via input 312.

In further implementations, input 312 may be a slider bar or any other form of graphical input mechanism. For example, interface 300 may include a chart that shows the tradeoff of coverage vs. precision for different values of a content selection parameter. In such a case, input 312 may correspond to a slider bar that allows the operator of interface 300 to select the degree of precision desired for a given content selection parameter value. In another implementation, interface 300 may include an input that allows a third-party content provider to specify how much money he or she is willing to spend each time the correct user is exposed to the provider's content. Based on the received amount, the system may translate the received amount into an appropriate degree of precision on behalf of the content provider.

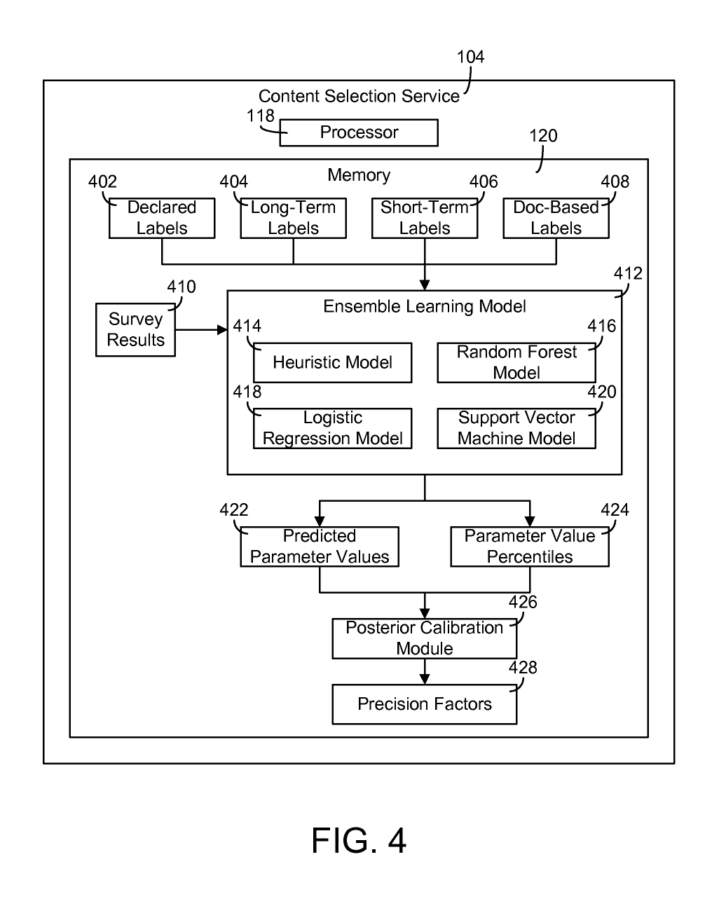

Referring now to FIG. 4, a block diagram is shown of one implementation of the content selection service of FIG. 1. In the implementation shown, memory 120 of content selection service 104 may store data and instructions that, when executed by processor 118, cause content selection service 104 to allow precision controls to be used with content selection parameters. For example, a third-party content provider may specify a desired level of precision for a specified content selection parameter value used by content selection service 104 to control which device identifiers are eligible to receive content from the provider. Content selection service 104 may predict content selection parameter values for a given device identifier based on data from any number of sources.

Memory 120 may include declared labels 402, which may be data from other services provided by the same entity as content selection service 104 (e.g., a social networking service, an email service, a game service, an auction service, a file sharing service, etc.) and/or from any other service that provides labels 402 to content selection service 104. In some implementations, declared labels 402 may correspond to user-provided information that is part of a user's account. For example, a user may agree that he or she is age 18+ for purposes of viewing content via a video sharing service. In another example, a user may provide information about himself or herself as part of a social networking profile. In one implementation, declared labels 402 may be predicted based on the actions performed relative to the service. For example, a content selection parameter value in declared labels 402 may be predicted based on the type of content requested by a device identifier via an online service (e.g., a particular video on a video sharing service may be associated with users having certain characteristics).

Memory 120 may include long-term labels 404 which are based on a long-term history of online actions associated with device identifiers. In general, long-term labels 404 may be based on any online actions over a time period greater than a day. For example, long-term labels may be based on a history of web browsing activity spanning a week, the previous thirty days, the past six months, the past year, or the entire browsing history for a device identifier. In many cases, the amount of time for the long-term history may correspond to a time limit specified in a privacy policy of the service. For example, the service's privacy policy may specify that browsing history may only be retained or used for up to thirty days. The online actions indicated by a device identifier's long-term history may be analyzed to predict one or more content selection parameter values for the device identifier. For example, assume that 90% of the logged-in users that access a particular webpage are females between the ages of 25-34. In such a case, content selection service 104 may predict that a device identifier that also visits the webpage and is not logged in corresponds to a user in the same group.

Memory 120 may include short-term labels 406 which are based on a short-term history of online actions associated with device identifiers. In general, short-term labels 406 may be based on any online actions attributable to a device identifier over a time period up to a full day. For example, short-term labels 406 may be based on a short-term history of online actions within the previous twenty four hours, twelve hours, four hours, one hour, or any other short-term time period. In one implementation, long-term labels 404 may be generated as part of a periodic batch job (e.g., on a daily or nightly basis), which short-term labels 406 may be recomputed whenever a change in a device identifier's short-term history is detected. For example, short-term labels 406 for a particular device identifier may be recomputed in response to the device identifier visiting another webpage. Based on the content of the newly accessed webpage and any other content in the identifier's short term history, one or more content selection parameter values may be predicted for the device identifier in short-term labels 406.

Memory 120 may include document-based labels 408 which are based on the most recently accessed content by device identifiers. For example, the most recently accessed webpage by a device identifier may be analyzed by content selection service 104 to predict one or more content selection parameter values for the device identifier. In some cases, the most recent online history for a device identifier may be used by content selection service 104 across some or all of long-term labels 404, short-term labels 406, and/or document-based labels 408. For example, short-term labels 406 may be recomputed based on the most recent webpage visit by a device identifier. In other cases, the most recent online actions by a device identifier may be treated separately by content selection service 104 to generate document-based labels 408.

In some cases, labels 402-408 may differ for a given device identifier. For example, the short-term label for the identifier may indicate that the represented user is female, while the declared label for the identifier may indicate that the represented user is male. According to various implementations, content selection service 104 is configured to analyze labels 402-408 to determine finalized, predicted content selection parameter values 422 for the device identifiers. In other words, content selection service 104 may aggregate data from different sources to predict the finalized content selection parameter values for a device identifier.

In one implementation, content selection service 104 may include an ensemble learning model 412. In general, an ensemble learning model operates by combining hypotheses from multiple learning models to derive a more accurate hypothesis. As shown, ensemble learning model 412 may utilize predictions from a heuristic model 414, random forest model 416, logistic regression model 418, support vector machine (SVM) model 420, combinations thereof, or other forms of machine learning models. Each of heuristic model 414, random forest model 416, logistic regression model 418, and SVM model 420 (e.g., either a linear or nonlinear SVM model) may receive labels 402-408 as input and generate one or more predicted content selection parameter values for a device identifier. For example, each of models 414-420 may determine a predicted age, gender, age and gender combination, or the like, based on labels 402-408. In some cases, models 414-420 may include multiple models to handle each parameter separately (e.g., models to determine a predicted age, models to determine a predicted gender, models to determine a predicted age/gender combination, etc.). Models 414-420 may operate to classify a device identifier within one or more classifications (e.g., age ranges, genders, age ranges combined with a gender, etc.). For example, random forest model 416 may evaluate labels 402-408 to predict that a user represented by a device identifier falls within a particular age/gender classification. Ensemble learning model 412 may evaluate the outputs of each of models 414-420 to determine the most accurate results as predicted parameter values 422 having associated percentiles 424.

In some implementations, each of models 414-420 may be trained using survey results 410, which may be treated as ground truth labels. Survey results 410 may include user-provided information asked as part of a survey that is distributed to any number of client devices. For example, a client device may receive a survey asking the corresponding user for information about himself or herself. In one implementation, survey results 410 may be used in conjunction with declared labels 402 as the training data for models 414-420 (e.g., by creating a set of survey answers that have been filtered by declared labels 402). Models 414-420 may be configured via training in some cases to favor certain groupings of labels 402-408 over others. For example, heuristic model 414 may be trained to favor the results of long-term labels 404 over document-based labels 408 over the course of time.

Predicted parameter values 422 may correspond to age, gender, or age/gender labels, according to various implementations. For example, ensemble learning model 412 may generate an age label Lₐ, a gender label L_{g}, or an age/gender label that combines both Lₐ and L_{g}. If one of the classifications in a hybrid classification (e.g., age/gender) cannot be determined from the label inputs to ensemble learning model 412, it may be marked as “UNKNOWN” while the other classification is maintained. For example, ensemble learning model 412 may still predict a gender, even if it is unable to determine an age range based on its inputs.

According to various implementations, content selection service 104 includes a posterior calibration module 426 configured to determine the probability that a particular device identifier falls within a particular classification. Posterior calibration module 426 may do so in real-time or near real-time, in some implementations. For example, assume that content selection service 104 utilizes a total of fourteen possible classifications (e.g., seven possible age ranges combined with two possible genders). In such a case, posterior calibration module 426 may determine how probable a device identifier, such as a cookie, falls within one of the fourteen possible classifications given all information associated with the device identifier in labels 402-408. In one implementation, posterior calibration model 426 may use confusion matrices to represent the accuracy of ensemble learning model 412 in relation to the actual values from survey results 410. Based on the confusion matrices, posterior calibration module 426 may generate precision factors 428, which represent the likelihood that a predicted parameter value 422 for a particular device identifier is accurate.

In one implementation, predicted parameter values 422 correspond to combined gender and age labels from ensemble learning model 412. In such a case, posterior calibration module 426 may quantize parameter value percentiles 424. For example, posterior calibration module 426 may quantize parameter value percentiles 424 into decile pairs (e.g., by breaking down percentiles 424 into ten groups for each of the gender and age labels). Alternatively, ventile pairs may be generated if survey results 410 contain a sufficient number of entries. Thus, posterior calibration module 426 may generate one hundred different decile pairs (i.e., ten deciles for the gender labels times ten deciles for the age labels), if the possible classifications correspond to a combination of a predicted age and gender.

For each decile or ventile pair generated by posterior calibration module 426, module 426 may compute a confusion matrix containing entries for each of the possible classifications (e.g., all fourteen possible age×gender classifications). Such a confusion matrix generated by posterior calibration module 426 may compare the actual values from a truth set (e.g., survey results 410) to the predictions from ensemble learning module 412. For example, assuming that there are fourteen possible age/gender classifications used by content selection service 104, each confusion matrix generated by posterior calibration module 426 may contain 14²=196 entries, with one edge of the matrix representing the predicted age/gender classes and the other edge representing the observed age/genders from survey results 410. Any other grouping of ages and/or genders may also be used (e.g., five groups of age ranges instead of seven groupings, etc.).

Posterior calibration module 426 may, for a particular device identifier, determine its corresponding precision factor 428 by evaluating its corresponding confusion matrix based on its deciles from parameter value percentiles 424. For example, assume that the device identifier has percentiles in percentiles 424 corresponding to the 2^{nd} decile for age and the 7^{th} decile for gender. In such a case, posterior calibration module 426 may analyze the corresponding confusion matrix for the 2^{nd} decile for age and the 7^{th} decile for gender. In some implementations, posterior calibration module 426 may take the normalized column of the confusion matrix that corresponds to the age/gender label for the device identifier in predicted parameter values 422. Thus, in some cases, precision factors 428 may be posterior distributions. For purposes of calibration, posterior calibration module 426 may utilize binning to determine the accuracy of ensemble learning model 412, in one implementation. Other calibration techniques may also be used in other implementations to increase the accuracy of ensemble learning model 412.

In cases in which only one classification is present in predicted parameter values 422 (e.g., age is present but gender is missing, gender is present but age is missing, etc.), posterior calibration module 426 may utilize a similar approach as when a predicted age/gender combination is present. In particular, posterior calibration module 426 may still represent the posterior using the same form of distribution as with age/gender combinations, even if one of the classifications is unavailable or unknown. For example, assume that there are fourteen possible age/gender classifications used by content selection service 104 (e.g., age 18-24 and male, age 18-24 and female, etc.). If an age is unknown, the gender posterior may be represented as [a,b] and broken down into fourteen classifications: [a/7, a/7, a/7, a/7, a/7, a/7, a/7, b/7, b/7, b/7, b/7, b/7, b/7, b/7]. Posterior calibration module 426 may then check whether the male and female age scores are identical and, if so, would set age=“UNKNOWN.” Similarly, if gender is missing and age is available, the age posterior may be represented as [a, b, c, d, e, f, g] and broken down into the following classifications [a/2, b/2, c/2, d/2, e/2, f/2, g/2, a/2, b/2, c/2, d/2, e/2, f/2, g/2].

According to various implementations, content selection service 104 may use precision factors 428 for purposes of selecting content for a device identifier. In one implementation, the predicted parameter values 422 and precision factors 428 may be used by content selection service 104 to determine the narrowest classification with a precision factor above a threshold amount. Content selection service 104 may search through the posterior distributions in precision factors 428 to identify the narrowest age/gender classification satisfying the threshold. For example, content selection service 104 may determine that the narrowest age/gender classification from parameter values 422 that has a precision factor of 80% or higher corresponds to the represented user being a male between the ages of 18-24 (e.g., as opposed to being classified in the age ranges of 18+, 18-34, etc.). Thus, if a third-party content provider specifies a gender and/or age range (e.g., via interface 300 shown in FIG. 3), content selection service 104 may determine whether a device identifier is eligible to receive content from the provider based on whether the narrowest content selection parameter value associated with the device identifier has a precision value above the threshold.

In further implementations, content selection service 104 may determine whether a device identifier is eligible to receive a particular piece of third-party content based in part on a precision factor specified by the third-party content provider. For example, if the precision factor specified by the third-party content provider is greater than the threshold used by content selection service 104, the content provider may reach a smaller pool of users than if a lower or no precision factor is specified (e.g., a higher degree of precision may come at the expense of having a larger pool of device identifiers eligible to receive content from the provider).

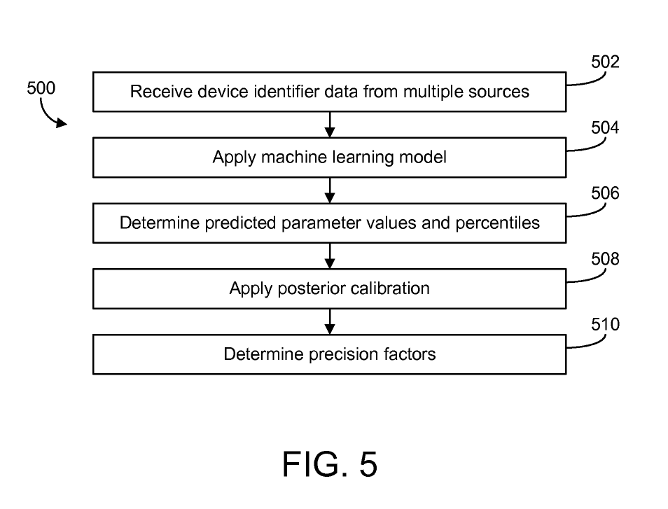

Referring now to FIG. 5, a flow diagram of one implementation of a process 500 for determining precision factors is shown. Process 500 generally includes receiving device identifier data from multiple sources (step 502), applying a machine learning model to the data (step 504), determining predicted content selection parameter values and percentiles (step 506), applying a posterior calibration to the parameter values and percentiles (step 508), and determining precision factors for the content selection parameter values (step 510). Process 500 may be implemented by one or more computing devices executing stored machine instructions. For example, process 500 may be implemented by content selection service 104 shown in FIGS. 1 and 4. In general, process 500 allows a content selection service to predict content selection parameter values for a device identifier and quantify how precise the predicted values are. Precision factors determined via process 500 may be used by the content selection service, in some cases, to control which device identifiers are eligible to receive a certain piece of third-party content.

Referring still to the implementation of FIG. 5, process 500 includes receiving device identifier data from multiple sources (step 502). The device identifier data may include, but is not limited to, data that is part of an online profile, data received from a content source that is operated by a different entity than the content selection service, data regarding a history of online actions performed by a device identifier over one or more time periods (e.g., long-term or short-term browsing histories, the current document-based labels, etc.), or any other such data. In some cases, the device identifier data may be received from another online service, such as a social networking service, a file sharing service, a video streaming service, an email service, a navigation service, a game service, or any other form of online service. For example, content selection service 104 shown in FIG. 4 may receive labels 402-408 from any number of different sources of data.

Referring still to the implementation of FIG. 5, process 500 includes applying one or more machine learning models to the device identifier data (step 504). According to various implementations, an ensemble learning model may compare the outputs of any number of machine learning models that use the received device identifier data as inputs. Any or all of the machine learning models may be trained using data that is considered to be truthful, such as user-specified survey data. The machine learning models may include, but are not limited to, heuristic models, random forest models, logistic regression models, SVM models (e.g., either linear or nonlinear), or any other form of machine learning model configured to predict content selection parameter values based on received device identifier data. In some cases, the ensemble model and its corresponding machine learning models may be configured to emphasize or deemphasize device identifier data based on its source. For example, long-term history data may be treated by the models as being more reflective of the true content selection parameter values than short-term history data.

Referring yet still to the implementation of FIG. 5, process 500 includes determining predicted parameter values and percentiles (step 506). In some cases, the ensemble learning model of step 504 may, based on the device identifier data, determine the predicted content selection parameter values and percentiles for a device identifier. For example, the ensemble learning model of step 504 may determine one or more predicted age ranges, genders, or combinations thereof for a device identifier. In addition, the ensemble learning model of step 504 may determine the percentiles for any predicted content selection parameter values. Where an ensemble learning model is used, the ensemble model may analyze the predictions from any number of predictive models to determine the predicted content selection parameter value. For example, the ensemble learning model may determine that a predicted content selection parameter value from a heuristic model is more likely the true value than a predicted parameter value from a random forest model.

Referring further still to the implementation of FIG. 5, process 500 includes applying a posterior calibration to the predicted parameter values and percentiles (step 508). In general, a posterior probability refers to the conditional probability of an event given a set of facts. Likewise, calibration refers to the process of converting classification scores or percentiles into probabilities corresponding to membership within the different classifications. For example, given the device identifier data from the multiple sources received in step 502 of process 500, the probability of the device identifier belonging to different age, gender, or combined age/gender categories may be determined (e.g., there is a 45% probability that the device identifier falls within the category corresponding to males age 18-24, etc.).

In various cases, posterior calibration may be applied by quantizing the percentiles determined in step 506 into deciles, ventiles, or any other quantized grouping. Confusion matrices may then be determined for each quantized grouping. In general, a confusion matrix operates to compare how well predicted parameter values match actual parameter values (e.g., ground truth values). For example, if two gender categories are used and seven total age ranges are used, each confusion matrix may be fourteen dimensional (e.g., two gender categories times seven age categories). Also, if the percentiles from step 506 are quantized into decile pairs (e.g., deciles from both the age and gender percentiles), one hundred different confusion matrices may be determined. The ground truth values may be determined based on survey answers, declared labels, combinations thereof, or the like. Smoothing techniques, such as Dirichlet smoothing, may also be used on the posterior. Such confusion matrices may be analyzed to determine posterior distributions for the different quantized percentiles. For example, a normalized column of a confusion matrix may be taken as a posterior distribution. In some cases, binning or another such technique may be used for purposes of calibration.

Referring still to the process of FIG. 5, process 500 includes determining precision factors for one or more content selection parameter values (step 510). Based on the posterior probabilities determined in step 508, precision factors may be determined that represent the likelihood of a device identifier falling within a particular category for a content selection parameter. For example, a device identifier may be associated with a content selection parameter value representing females age 18-24 with a precision of 80% and a content selection parameter value representing females age 25-34 with a precision of 30%.

Precision factors may be used in any number of different ways by a content selection service. In some cases, the service may analyze content selection parameter values having precision factors above a threshold amount to select the narrowest parameter value. For example, the content selection service may select the narrowest age range having a precision factor greater than 80%. In further cases, a third-party content provider may specify a desired level of precision. For example, interface 300 shown in FIG. 3 may be used by a third-party content provider to specify that he or she wishes to provide content to users predicted to be within the 24-35 age range with a degree of precision of 90% or higher. If so, the content selection service may determine whether or not a device identifier is eligible to receive content from the provider based on its predicted content selection parameter values and associated precision factors.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels,” etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

What is claimed is:

1. A method of determining a precision factor for a content selection parameter value comprising:
receiving, at one or more processors, device identifier data from multiple sources comprising data indicative of online actions associated with a device identifier or user-specified data;
applying, by the one or more processors, a machine learning model to the device identifier data;
determining predicted content selection parameter values and percentiles using the machine learning model and the device identifier data;
applying, by the one or more processors, a posterior calibration to the content selection parameter values and percentiles; and
determining one or more precision factors associated with the predicted content selection parameter values.

2. The method of claim 1, wherein applying, by the one or more processors, the machine learning model to the device identifier data comprises:
applying a plurality of different machine learning models to the device identifier data; and
using an ensemble learning model to select one or more outputs from the plurality of machine learning models as the predicted content selection parameter values and percentiles.

3. The method of claim 2, further comprising:
receiving survey data; and
using the received survey data to train the ensemble learning model.

4. The method of claim 1, wherein applying the posterior calibration to the content selection parameter values and percentiles comprises:
quantizing the percentiles; and
for each quantized percentile, determining a confusion matrix.

5. The method of claim 1, wherein the multiple sources for the device identifier data comprise two or more of: current browsing history of the device identifier, short-term browsing history of the device identifier, long-term browsing history of the device identifier, labels received from a third-party content source, or user-declared labels.

6. The method of claim 1, wherein the content selection parameter values correspond to at least one of: predicted genders, predicted age ranges, or combined genders and age ranges.

7. The method of claim 1, further comprising:
using the one or more precision factors to select the narrowest content selection parameter value for the device identifier.

8. A system comprising one or more processors operable to:
receive device identifier data from multiple sources comprising data indicative of online actions associated with a device identifier or user-specified data;
apply a machine learning model to the device identifier data;
determine predicted content selection parameter values and percentiles using the machine learning model and the device identifier data;
apply a posterior calibration to the content selection parameter values and percentiles; and
determine one or more precision factors associated with the predicted content selection parameter values.

9. The system of claim 8, wherein the one or more processors are operable to apply the machine learning model to the device identifier data by:
applying a plurality of different machine learning models to the device identifier data; and
using an ensemble learning model to select one or more outputs from the plurality of machine learning models as the predicted content selection parameter values and percentiles.

10. The system of claim 9, wherein the one or more processors are operable to:
receive survey data; and
use the received survey data to train the ensemble learning model.

11. The system of claim 8, wherein the one or more processors apply the posterior calibration to the content selection parameter values and percentiles by:
quantizing the percentiles; and
for each quantized percentile, determining a confusion matrix.

12. The system of claim 8, wherein the multiple sources for the device identifier data comprise two or more of: current browsing history of the device identifier, short-term browsing history of the device identifier, long-term browsing history of the device identifier, labels received from a third-party content source, or user-declared labels.

13. The system of claim 8, wherein the content selection parameter values correspond to at least one of: predicted genders, predicted age ranges, or combined genders and age ranges.

14. The system of claim 8, wherein the one or more processors are operable to:
use the one or more precision factors to select the narrowest content selection parameter value for the device identifier.

15. A computer-readable storage medium having machine instructions stored therein, the instructions being executable by a processor to cause the processor to perform operations comprising:
receiving device identifier data from multiple sources comprising data indicative of online actions associated with a device identifier or user-specified data;
applying a machine learning model to the device identifier data;
determining predicted content selection parameter values and percentiles using the machine learning model and the device identifier data;
applying a posterior calibration to the content selection parameter values and percentiles; and
determining one or more precision factors associated with the predicted content selection parameter values.

16. The computer-readable storage medium of claim 15, wherein applying the machine learning model to the device identifier data comprises:
applying a plurality of different machine learning models to the device identifier data; and
using an ensemble learning model to select one or more outputs from the plurality of machine learning models as the predicted content selection parameter values and percentiles.

17. The computer-readable storage medium of claim 16, wherein the operations further comprise:
receiving survey data; and
using the received survey data to train the ensemble learning model.

18. The computer-readable storage medium of claim 15, wherein applying the posterior calibration to the content selection parameter values and percentiles comprises:
quantizing the percentiles; and
for each quantized percentile, determining a confusion matrix.

19. The computer-readable storage medium of claim 15, wherein the content selection parameter values correspond to at least one of: predicted genders, predicted age ranges, or combined genders and age ranges.

20. The computer-readable storage medium of claim 15, wherein the operations further comprise:
using the one or more precision factors to select the narrowest content selection parameter value for the device identifier.
